(19) United States
(12) Patent Application Publication
(10) Pub. No.: US 2008/0268722 A1
(43) Pub. Date: Oct. 30, 2008

(54) Screw terminal and service device

(75) Inventors: Ralf Wieland, Waldbrunn (DE); Klaus-Peter Eppe, Waldbrunn (DE); Albrecht Vogel, Stutensee (DE); Wolfgang Wilhelm, Heddesheim (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/081,777

(22) Filed: Apr. 21, 2008

(30) Foreign Application Priority Data
Apr. 19, 2007 (DE) 10 2007 018 520.2
Dec. 13, 2007 (DE) 10 2007 060 077.3

(51) Int. Cl. H01R 4/36

(52) U.S. Cl. 439/814

(57) ABSTRACT

The disclosure relates to a screw terminal for an electrical service device for connecting an electrical connecting conductor, which can be inserted through an insertion opening in the housing wall of the service switching device into the screw terminal. The screw terminal includes a terminal frame with a first transverse limb, which has a threaded hole for accommodating a clamping screw, and a clamping screw, which protrudes through the threaded hole into the terminal frame. The clamping frame, in its installed position in the housing of the service switching device, is guided displaceably parallel to the mid-axis of the clamping screw. The connecting conductor can be fixedly clamped in the terminal frame. That part of the terminal frame with which touching contact can be made in the installed position through the insertion opening from outside the device housing is covered by an insulating material. The disclosure furthermore relates to a service device with at least one screw terminal according to the disclosure.

### RELATED APPLICATIONS

This application claims priority under 35 U.S.C. §119 to German Patent Application No. 10 2007 018 520.2 filed in Germany on Apr. 19, 2007, and German Patent Application No. 10 2007 060 077.3 filed in Germany on Dec. 13, 2007, the entire contents of which are hereby incorporated by reference in their entireties.

### TECHNICAL FIELD

The disclosure relates to a screw terminal for an electrical service device. The disclosure furthermore relates to an electrical service device.

### BACKGROUND INFORMATION

Screw terminals are in widespread use in particular in domestic installations technology and serve the purpose of connecting electrical connecting conductors to a service device, for example a line circuit breaker or a residual current circuit breaker.

Such service switching devices have an insulating housing with at least one front-panel side, a fixing side, which is opposite said front-panel side and on which fixing apparatuses for snapping on or otherwise fixing the service switching device on a mounting rail or another fixing device can be provided, and with narrow and broad sides which connect the front-panel side and the fixing side.

The screw terminals for connecting the connecting conductors have been fitted in the region of the narrow sides in the service switching device. The other components or assemblies which are used for proper functioning of the service switching device, such as releases, switching levers and contact pieces, an arc quenching device, adjustment devices etc., are located in the interior of the service switching device.

Known screw terminals have a terminal frame with a rectangular cross section and a clamping screw, which protrudes through a threaded hole in a first transverse limb of the terminal frame into said terminal frame. By means of turning the clamping screw, the terminal frame is moved along the axis of the clamping screw. A clamping area for fixedly clamping a connecting conductor is formed in the interior of the terminal frame.

A connecting conductor which has been inserted into the terminal frame is therefore fixedly clamped in the clamping area between the clamping screw and a second transverse limb, which is opposite the first transverse limb, of the terminal frame.

Other known screw terminals also have a contact strip, onto which the clamping screw presses so that the connecting conductor is fixedly clamped between the contact strip and the second transverse limb.

In a further generic type of known screw terminals, in this case the contact strip, in the installed position of the terminal in the housing, is mounted fixed in position and the terminal frame is mounted in such a way that it is longitudinally displaceable, in relation to the contact strip, parallel to a housing narrow side. For this purpose, the contact strip can be fixedly clamped, for example, in grooves or between protruding webs, which are integrally formed on the housing wall in a corresponding position in the housing interior. The contact strip divides the clamping area of the terminal frame into a first partial clamping area, which is positioned between the first transverse limb and the contact strip, and a second partial clamping area, which is positioned between the contact strip and the second transverse limb.

If the clamping screw is screwed in, it first hits the contact strip, whereby it fixedly clamps a connecting conductor which may have been inserted into the terminal frame between the contact strip and the first transverse limb in the first partial clamping area. As the clamping screw is turned further in the screw-in direction, the clamping screw is supported on the contact strip, and the terminal frame is as a result pushed upwards in the direction of the free end of the clamping screw. As a result, the second transverse limb is moved upwards in the direction towards the contact strip. A connecting conductor which has been inserted in the second partial clamping area is thereby fixedly clamped between the contact strip and the second transverse limb.

The housing of the service device, in whose interior such a screw terminal is arranged, has an insertion opening, through which a connecting conductor can be inserted into the housing and into the clamping area of the terminal frame. If the connecting conductor is fixedly clamped, the second transverse limb of the terminal frame, against which the connecting conductor to be connected bears, may be visible, or it may be possible for touching contact to be made with it, through the insertion opening. Since the terminal frame is live during operation, touching contact with the terminal frame should be avoided.

### SUMMARY

A screw terminal is disclosed whereby touching contact with a live terminal frame when the connecting conductor is fixedly clamped can be prevented.

A screw terminal for an electrical service device is disclosed for connecting an electrical connecting conductor, which can be inserted through an insertion opening in a housing wall of the service switching device into the screw terminal, comprising: a terminal frame with a first transverse limb, which has a threaded hole for accommodating a clamping screw; and a clamping screw, which protrudes through the threaded hole into the terminal frame, the terminal frame, in an installed position in the housing of the service switching device, being guided displaceably parallel to a mid-axis of the clamping screw, and the connecting conductor being configured to be fixedly clamped in the terminal frame, wherein a part of the terminal frame configured for touching contact in the installed position through the insertion opening from outside the device housing is covered by an insulating material.

### BRIEF DESCRIPTION OF THE DRAWINGS

The disclosure, advantageous configurations and improvements of the disclosure and further advantages will be explained and described in more detail with reference to the drawings, in which two exemplary embodiments of the disclosure are illustrated and in which:

FIG. 1 shows a first exemplary embodiment of a screw terminal according to the disclosure;

FIG. 2 shows an exemplary insulating part according to the disclosure;

FIG. 3 shows an exemplary electrical service switching device in view of the terminal insertion opening;

FIG. 4 shows a view into an open housing of an exemplary service switching device according to the disclosure; and

FIG. 5 shows a second exemplary embodiment of a screw terminal according to the disclosure.

### DETAILED DESCRIPTION

A part of a terminal frame configured for touching contact in an installed position through an insertion opening from outside a device housing is covered by an insulating material. In accordance with an exemplary embodiment, at least one subregion of a second transverse limb, which is opposite the first transverse limb, with which subregion touching contact can be made in the installed position of the terminal through the insertion opening from outside the device housing, is covered on its side remote from the clamping screw with an insulating layer.

As a result, unintentional touching contact with live parts of the terminal frame through the insertion opening can be eliminated. If, for example, the clamping screw is tightened and the movably guided terminal frame is displaced upwards in the housing in the direction towards the clamping screw opening, so that the lower side, which is remote from the clamping screw, of the second transverse limb is visible, and touching contact can be made with it, through the insertion opening, in the case of an exemplary screw terminal according to the disclosure it is now only possible to make touching contact with the insulating layer, but not with the bare metal of the terminal or the terminal frame. As a result, reliable protection against damage to personnel as a result of the effect of current is provided.

In accordance with a further exemplary embodiment, the insulating layer is formed by an insulating plate, which is coupled to the terminal frame. In accordance with a further exemplary embodiment, the insulating plate can be formed by virtue of the fact that a plate-shaped insulating part, which covers a region, which is formed by the second transverse limb, of a first end side of the terminal frame and at least one subregion of the second transverse limb on its side remote from the clamping screw, is arranged in the region of the second transverse limb. In this embodiment, the insulating part can be approximately L-shaped and can be plugged or clipped onto the terminal frame with one of the two limbs forming the L-shape.

In accordance with another exemplary embodiment, the insulating layer is formed by an insulating foil fitted on the second transverse limb or an insulating film which has been sprayed onto the second transverse limb.

In accordance with a further exemplary embodiment of the disclosure, an insulating part, which covers at least a region, which is formed by the second transverse limb, of a first end side of the terminal frame, is coupled to the terminal frame in the region of a second transverse limb, which is opposite the first transverse limb. The region, which is covered by the insulating part, of the first end side of the terminal frame is that region with which touching contact can be made through the insertion opening of the housing from the outside. The coupling of the insulating part to the terminal frame can take place by means of plugging-on, clipping-on, snapping-on, adhesive bonding, screwing-on or in another way.

The insulating part prevents touching contact from being made with the region, which is formed by the second transverse limb, of the first end side.

In accordance with a further exemplary embodiment of the disclosure, the insulating part extends parallel to the first end side beyond the side, which is remote from the clamping screw, of the second transverse limb. As a result, to a certain extent a web is formed which protrudes beyond the second transverse limb parallel to the first end side on the side remote from the clamping screw. An advantageous effect of this exemplary embodiment is that, in the installed position of the terminal in the terminal accommodating area of the housing of the service switching device, an exemplary web according to the disclosure reduces the free cross section of the insertion opening if the clamping screw is tightened and the movably guided terminal frame is displaced upwards in the housing in the direction towards the clamping screw opening so that the lower side, which is remote from the clamping screw, of the second transverse limb is visible, and touching contact can be made with it, through the insertion opening. By providing the web provided in accordance with the disclosure with suitable dimensions, the remaining insertion opening can be made to be so small that a human finger or a test finger can no longer pass through.

In accordance with a further exemplary embodiment of the disclosure, the insulating part covers subregions of the regions, which are formed by the longitudinal limbs, of the first end side or else completely covers the regions, which are formed by the longitudinal limbs, of the first end side.

In accordance with a further exemplary embodiment of the disclosure, the insulating part also covers a region, which is formed by the first transverse limb, of the first end side.

In accordance with a further exemplary embodiment of the disclosure, the insulating part is fixed on the terminal frame by means of at least two snap-action hooks.

In accordance with a further exemplary embodiment of the disclosure, the insulating part can be dimensioned in such a way that it is impossible for a finger to be plugged through an insertion opening into the service device.

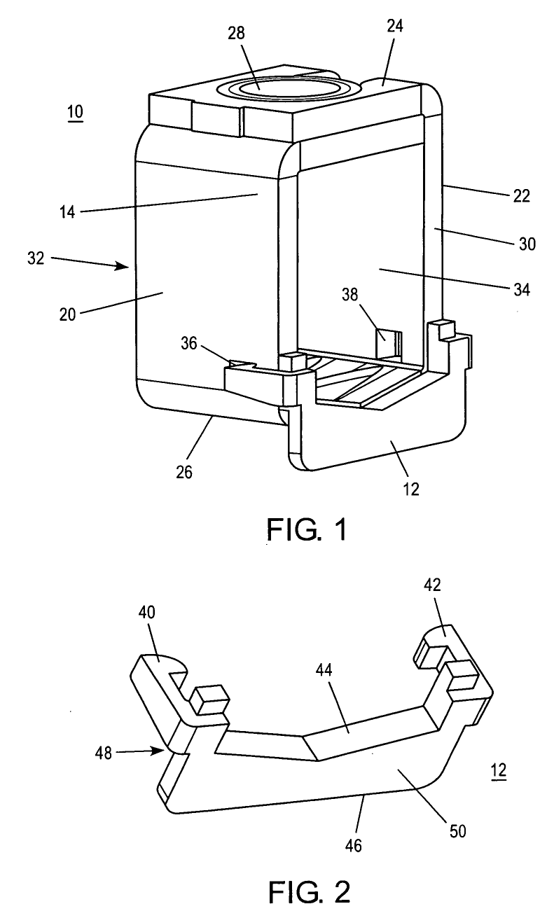

FIG. 1 illustrates an exemplary screw terminal 10 according to the disclosure. The screw terminal 10 comprises a terminal frame 14, a clamping screw (not shown here) and an insulating part 12. The terminal frame 14 and the clamping screw are each made of an electrically conductive material, such as metal, for example stainless steel or a copper alloy.

In this example, the terminal frame 14 is provided for accommodating a connecting conductor with a relatively large cross section of 50 mm². However, the disclosure can also be applied to other types of terminal frames, for example for a conductor cross section of 35 mm².

The terminal frame 14 is approximately cuboid and has an approximately rectangular cross section with a first longitudinal limb 20, a second longitudinal limb 22, which runs parallel thereto, a first transverse limb 24, which runs at right angles to the longitudinal limbs 20, 22, and a second transverse limb 26, which runs parallel to the first transverse limb 24.

A first end side 30 and a second end side 32, which is hidden in this illustration, run at right angles to the longitudinal limbs 20, 22 and at right angles to the transverse limbs 24, 26. The first end side 30 has a connection opening 34, which takes up approximately the entire area of the first end side 30 and is bordered by the longitudinal limbs 20, 22 and the transverse limbs 24, 26. The second end side 32, which runs parallel to the first end side 30, has a similar form.

In this example, the terminal frame 14 is produced from a sheet-metal strip, which is bent in such a way that it takes on the above described form. The ends of the sheet-metal strip overlap one another in a region of the first transverse limb 24.

The first transverse limb 24 has a threaded hole 28, into which a clamping screw can be inserted. A connecting conductor, which has been inserted into the connection opening 34, can therefore be fixedly clamped by tightly turning the clamping screw between the clamping screw and the second transverse limb 26.

An insulating part 12 is fitted in the region of the second transverse limb 26 in such a way that it covers part of the first end side 30. In this example, the insulating part 12 covers the region, which is formed by the second transverse limb 26, of the first end side 30 and relatively small subregions of the regions, which are formed by the longitudinal limbs 20, 22, of the first end side 30.

The insulating part 12 only can be configured to cover the region, which is formed by the second transverse limb 26, of the first end side 30. Alternatively, the insulating part 12 can be configured to cover larger subregions of the regions formed by the longitudinal limbs 20, 22 or for the insulating part 12 to completely cover the regions, which are formed by the longitudinal limbs 20, 22, of the first end side 30. In an alternate embodiment, the region, which is formed by the first transverse limb 24, of the first end face 30 can also be covered by the insulating part 12.

The insulating part 12 can be configured in such a way that it not only covers regions and/or subregions of the first end side 30 of the terminal frame 14, but in addition extends beyond the side, which is remote from the clamping screw, of the second transverse limb 26, parallel to the first end side 30. To a certain extent a web is then formed which protrudes beyond the second clamping limb downwards.

A first fixing opening 36 and a second fixing opening 38 are introduced into the first longitudinal limb 20 and into the second longitudinal limb 22, respectively. These fixing openings 36, 38 can serve the purpose of fixing the insulating part 12 by means of corresponding snap-action hooks.

FIG. 2 illustrates the insulating part 12 of FIG. 1. The insulating part 12 is produced from an electrically insulating material and has substantially the form of a flat plate. It has a width which correlates with the width of the second transverse limb 26 of the terminal frame 14.

If the insulating part 12 is fixed on the terminal frame 14, a rear side 48, which is hidden in this illustration, of the insulating part 12 faces the terminal frame 14 and the front-panel side 50, which is opposite the rear side 48, of the terminal covering part is remote from the terminal frame 14.

In the edge regions, the insulating part 12 has a first snap-action hook 40 and a second snap-action hook 42, which are configured in such a way that they latch into the fixing openings 36, 38 of the terminal frame 14 and therefore fix the insulating part 12 on the terminal frame 14.

The insulating part 12 has a top region 44, which is shaped in such a way that the insulating part 12, if it is fixed on the terminal frame 14, terminates flush with the side of the second transverse limb 26 which faces the clamping screw.

The height of the insulating part 12, i.e. the distance between the top region 44 and a base region 46, which is opposite the top region 44, is dimensioned in such a way that the insulating part 12, if it is fixed on the terminal frame 14, extends beyond that side of the second transverse limb 26 which is remote from the clamping screw.

In this example, the insulating part 12 has two snap-action hooks 40, 42 for fixing it to the terminal frame 14. The insulating part 12 can be configured to have three or more snap-action hooks for fixing it to the terminal frame 14. For example, a snap-action hook can be arranged on the rear side 48 of the insulating part 12 in such a way that it latches into a fixing opening provided for this purpose in the second transverse limb 26 of the fixing frame 14.

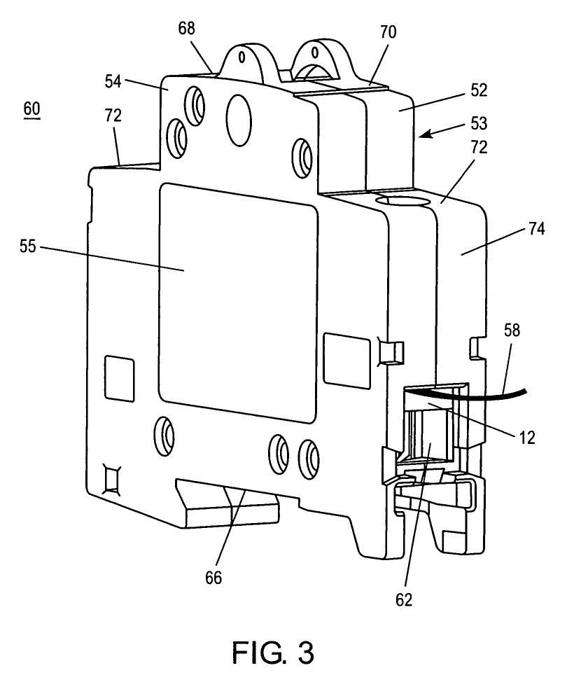

FIG. 3 illustrates an electric service device 60, for example a line circuit breaker. The service device 60 comprises a first housing part 52 and a second housing part 54, which surround the live parts of the service device 60.

That side of the first housing part 52 which is remote from the second housing part 54 is referred to as the first broad side 53 and is hidden in this illustration. That side of the second housing part 54 which is remote from the first housing part 52 is referred to as the second broad side 55.

A fixing side 66 of the service device 60 is at right angles with respect to the broad side 53, 55. The fixing side 66 is configured in such a way that the service device 60 can be fixed on a mounting rail (not illustrated here), for example a top-hat rail, by means of this fixing side 66.

That side of the service device 60 which is opposite the fixing side 66 is referred to as the front-panel side 68. The front-panel side 68 comprises a central region, which is referred to as the leading front panel 70, and two adjoining regions, which are set back with respect to the leading front panel 70 and are referred to as the trailing front panel 72.

The narrow sides, of which only the first narrow side 74 is visible in the illustration shown, run at right angles to the broad sides 53, 55 and at right angles to the fixing side 66 and the front-panel side 68.

The housing parts 52, 54 are considered in such a way that they form, in the region of the first narrow side 74, an insertion opening 62, through which an electrical connecting conductor 58 can be inserted into the interior of the housing of the service device 60. A screw terminal, which is only partially visible in this illustration, is located in the interior of the housing of the service device 60 and directly adjacent to the insertion opening 62. The connecting conductor 58 is inserted through the insertion opening 62 into the connection opening 34 of the terminal frame 14 of the screw terminal 10 and fixedly clamped there in a known manner.

An insulating part 12 is fitted on the screw terminal 10, beneath the connecting conductor 58 in the illustration shown here. The insulating part 12 covers the region, which is formed by the second transverse limb, of the end side of the terminal frame and extends away from the terminal frame, downwards in the illustration shown.

The remaining parts of the live terminal frame are covered by the housing parts 52, 54. There is therefore no live part of the service device 60 which is visible or with which touching contact can be made from the outside. Owing to the expansion of the insulating part 12 away from the terminal frame, i.e. downwards in the illustration shown, in addition the insertion opening 62 is reduced in size. The insertion of articles into the insertion opening 62 is therefore also made more difficult.

The expansion of the insulating part 12 can be in particular dimensioned such that it is not possible for a finger to be plugged through the insertion opening 62 into the service device 60. Such an embodiment can be configured such that it is not possible to make touching contact with live parts in the interior of the service device 60 which are not visible from the outside.

The housing parts 52, 54 have, in the interior of the housing of the service device 60, groove-like depressions, which run parallel to the first narrow side 74 and parallel to the mid-axis of the clamping screw 64 and in which the insulating part 12 slides.

In the example shown in FIG. 3, the terminal frame is provided for a conductor cross section of 50 mm². The connected connecting conductor 58 has a relatively small cross section of only 6 mm², however. In order to fixedly clamp this connecting conductor 58, the second transverse limb can be positioned relatively close to the clamping screw of the screw terminal. In the illustration shown, the terminal frame and therefore also the insulating part 12 are therefore located relatively far up.

This arrangement, in relation to the risk associated with unintentional touching contact with live parts, can represent a critical situation since the remaining insertion opening 62 has a maximum size. Without any additional measures such as an insulating part 12 according to the disclosure being plugged on, it would easily be possible to touch the terminal frame with a finger through the insertion opening 62. The insulating part 12 in the illustration shown by means of its web reduces the size of the insertion opening, with the result that touching contact is prevented.

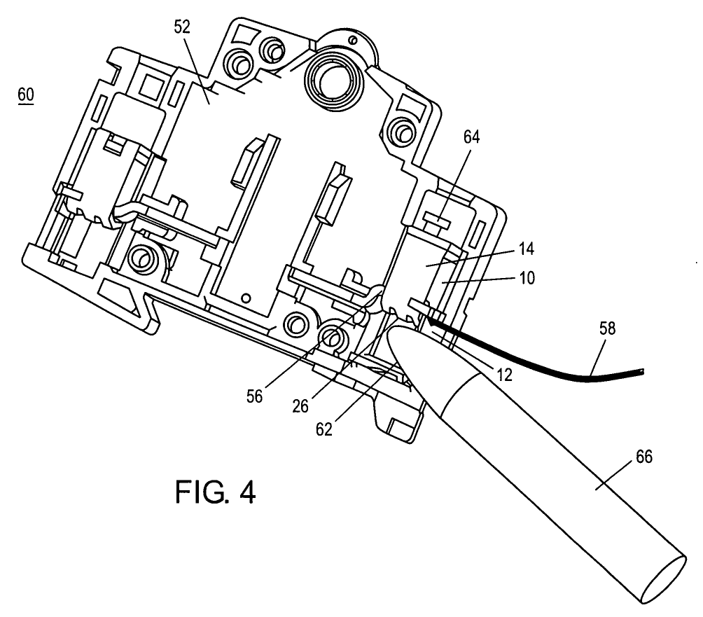

FIG. 4 illustrates the service device 60 known from FIG. 3 with the housing open. A first housing part 52 accommodates a screw terminal and a contact strip 56, the screw terminal 10 being arranged at the edge of the first housing part 52. The flat contact strip 56 is positioned in such a way that one end is located within the terminal frame 14 of the screw terminal 10, from where the contact strip 56 protrudes into the interior of the housing. The contact strip is mounted in such a way that it is fixed in position in relation to the housing halves 52, 54, for example by it being fixedly clamped in corresponding grooves which are formed by webs integrally formed on the housing inner side. The terminal frame 14 is guided in the housing interior in such a way that it is longitudinally displaceable parallel to the direction of longitudinal extent of the first narrow side 74 of the housing.

A further screw terminal with a further contact strip, which has the same design and on which no further details are given here, is located at that edge of the first housing part 52 which is opposite the screw terminal 10. The electrically active parts, such as a tripping apparatus, for example, are not illustrated here.

A connecting conductor 58 is connected to the screw terminal 10. In the process, a clamping screw 64 presses on the contact strip 56. As a result, the terminal frame 14 is moved upwards in the direction towards the trailing front-panel side 72, with the result that the connecting conductor 58 is fixedly clamped between the contact strip 56 and the second transverse limb 26 of the terminal frame 14. The clamping screw 64 is accessible for an actuating tool, for example a screwdriver, through a hole, which is located in the trailing front panel 72 of the service device 60 when the housing is closed.

An insulating part 12 is fitted in the region of the second transverse limb 26 of the terminal frame 14 and reduces the size of the insertion opening 62 of the service device 60, as is already illustrated in FIG. 3.

In the illustration shown in FIG. 4, a so-called test finger 66 is inserted into the remaining insertion opening 62. The test finger 66 has an approximately cylindrical form with a diameter of, for example, approximately 12 mm and tapers conically at the end which is inserted into the insertion opening 62.

The test finger 66 abuts the boundary of the insertion opening 62 which is formed by the first housing part 52 and the insulating part 12. Further insertion of the test finger 66 into the interior of the service device 60 is not possible. That end of the test finger 66 which is inserted into the service device 60 does not come into touching contact with a live part. In particular, said end of the test finger 66 has a predetermined distance from the second transverse limb 26 of the terminal frame 14.

As has already been mentioned, the terminal frame 14 is provided for a relatively large conductor cross section of 50 mm². The connected connecting conductor 58 has a relatively small cross section of only 6 mm², however.

If a connecting cable with a relatively large conductor cross section is connected, the insulating part 12 is located further down in the illustration shown, as a result of which the expansion of the insertion opening 62 in the direction of the longitudinal axis of the clamping screw 64 is further reduced in size. In this case, the test finger 66 cannot be inserted as deeply into the service device 60 as shown in the illustration.

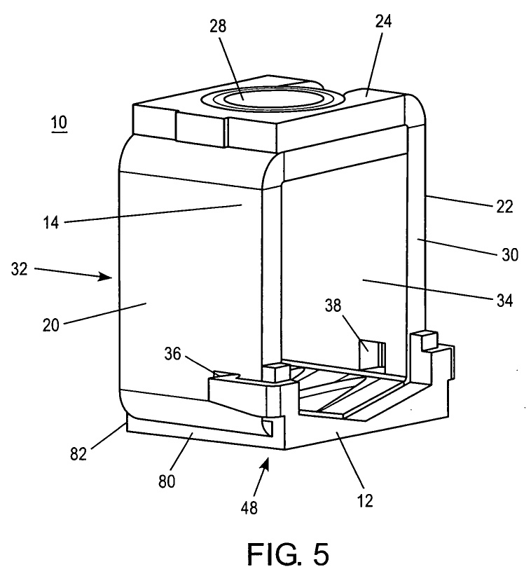

FIG. 5 shows a further embodiment of a screw terminal according to the disclosure. Identical or functionally identical parts or assemblies in this case have the same reference numerals as in FIG. 1.

The insulating part 12 shown in FIG. 5 does not have a web which protrudes downwards and protrudes, in the installed position of the terminal, into the insertion opening of the terminal accommodating area and reduces its size. Instead, a cover plate 80 made of electrically insulating material is arranged on the rear side 48 of the insulating part 12, which cover plate covers the lower side of the terminal frame 14. The cover plate 80 in this illustration is designed to be integral with the insulating part 12; however, it can also be a separate part.

In the rear region 82, the cover plate 80 can be fixed on the terminal frame 14 by means of means not shown here, for example snap-action hooks.

If the cover plate 80 is formed as a separate part, it has further fixing means for fixing it on the terminal frame 14 or on the insulating part 12 in the region adjacent to the insulating part 12.

In a further variant, no attachment part is fitted but instead the lower side of the terminal frame has an insulating foil adhesively bonded on it or is sprayed with an insulating layer.

In a further variant, which is not illustrated in the figures here, the insulating part 12 can also bear both the downwardly pointing web and the cover plate 80. Multiple protection against unintentional touching contact with the terminal can therefore be provided in this case.

In a further variant, which is likewise not illustrated in the figures, the insulating part 12 can also bear the downwardly pointing web, as illustrated in FIG. 1, and the lower side of the terminal frame can have an insulating foil adhesively bonded to it or be sprayed with an insulating layer or be covered by an insulating film in some other way. Multiple protection against unintentional touching contact with a terminal is therefore also provided.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Screw terminal
12 Insulating part
14 Terminal frame
20 First longitudinal limb
22 Second longitudinal limb
24 First transverse limb
26 Second transverse limb
28 Threaded hole
30 First end side
32 Second end side
34 Connection opening
36 First fixing opening
38 Second fixing opening
40 First snap-action hook
43 Second snap-action hook
44 Top region
46 Base region
48 Rear side
50 Front-panel side of terminal covering part
52 First housing part
53 First broad side
54 Second housing part
55 Second broad side
56 Contact strip
58 Connecting conductor
60 Service device
62 Insertion opening
64 Clamping screw
66 Fixing side
68 Front-panel side of service device
70 Leading front-panel
73 Trailing front-panel
74 First narrow side
80 Cover plate
82 Rear region of cover plate

What is claimed is:

1. Screw terminal for an electrical service device for connecting an electrical connecting conductor, which can be inserted through an insertion opening in a housing wall of the service switching device into the screw terminal, comprising:
a terminal frame with a first transverse limb, which has a threaded hole for accommodating a clamping screw; and
a clamping screw, which protrudes through the threaded hole into the terminal frame, the terminal frame, in an installed position in the housing of the service switching device, being guided displaceably parallel to a mid-axis of the clamping screw, and the connecting conductor being configured to be fixedly clamped in the terminal frame, wherein a part of the terminal frame configured for touching contact in the installed position through the insertion opening from outside the device housing is covered by an insulating material.

2. Screw terminal according to claim 1, wherein at least one subregion of a second transverse limb, which is opposite the first transverse limb, is configured for touching contact in the installed position of the terminal through the insertion opening from outside the device housing, and is covered on a side remote from the clamping screw with an insulating layer.

3. Screw terminal according to claim 2, wherein the insulating layer is formed by an insulating plate, which is coupled to the terminal frame.

4. Screw terminal according to claim 3, wherein a plate-shaped insulating part is arranged in the region of the second transverse limb, which insulating part covers a region, which is formed by the second transverse limb, of a first end side of the terminal frame and at least one subregion of the second transverse limb on its side remote from the clamping screw.

5. Screw terminal according to claim 2, wherein the insulating layer is formed by an insulating foil, which is fitted on the second transverse limb, or an insulating film, which is sprayed onto the second transverse limb.

6. Screw terminal according to claim 1, wherein, in the region of a second transverse limb, which is opposite the first transverse limb, an insulating part is coupled to the terminal frame, which insulating part covers at least one region, which is formed by the second transverse limb, of a first end side of the terminal frame.

7. Screw terminal according to claim 6, wherein the insulating part extends parallel to the first end side beyond that side of the second transverse limb which is remote from the clamping screw.

8. Screw terminal according to claim 6, wherein the insulating part covers subregions of the regions, which are formed by the longitudinal limbs, of the first end side, or wherein the insulating part completely covers the regions, which are formed by the longitudinal limbs, of the first end side.

9. Screw terminal according to claim 6, wherein the insulating part covers a region, which is formed by the first transverse limb, of the first end side.

10. Screw terminal according to claim 6, wherein the insulating part is fixed on the terminal frame by means of at least two snap-action hooks.

11. Screw terminal according to claim 6, wherein the insulating part is dimensioned in such a way that it is impossible to plug a finger through an insertion opening into the service device.

12. Screw terminal according to claim 1, wherein the connecting conductor can be fixedly clamped between the second transverse limb and the clamping screw.

13. Screw terminal according to claim 1, wherein a contact strip is provided within the terminal frame, the clamping screw pressing on said contact strip, and wherein the connecting conductor can be fixedly clamped between the second transverse limb and the contact strip.

14. Service device, having at least one screw terminal for an electrical service device for connecting an electrical connecting conductor, which can be inserted through an insertion opening in a housing wall of the service switching device into the screw terminal, comprising:
a terminal frame with a first transverse limb, which has a threaded hole for accommodating a clamping screw; and
a clamping screw, which protrudes through the threaded hole into the terminal frame, the terminal frame, in an installed position in the housing of the service switching device, being guided displaceably parallel to a mid-axis of the clamping screw, and the connecting conductor being configured to be fixedly clamped in the terminal frame, wherein a part of the terminal frame configured for touching contact in the installed position through the insertion opening from outside the device housing is covered by an insulating material.

15. Service device, having at least one screw terminal for an electrical service device for connecting an electrical connecting conductor, which can be inserted through an insertion opening in a housing wall of the service switching device into the screw terminal, comprising:
a terminal frame with a first transverse limb, which has a threaded hole for accommodating a clamping screw; and
a clamping screw, which protrudes through the threaded hole into the terminal frame, the terminal frame, in an installed position in the housing of the service switching device, being guided displaceably parallel to a mid-axis of the clamping screw, and the connecting conductor being configured to be fixedly clamped in the terminal frame, wherein a part of the terminal frame configured for touching contact in the installed position through the insertion opening from outside the device housing is covered by an insulating material; and
wherein a contact strip is provided within the terminal frame, the clamping screw pressing on said contact strip, wherein the connecting conductor can be fixedly clamped between the second transverse limb and the contact strip.
